(19) United States
(12) Patent Application Publication
(10) Pub. No.: US 2024/0150877 A1
(43) Pub. Date: May 9, 2024

(54) FE-NI ALLOY, IN PARTICULAR FOR TRANSPORTING AND STORING LIQUID HYDROGEN

(71) Applicant: APERAM, LUXEMBOURG (LU)

(72) Inventor: Pierre-Louis REYDET, URZY (FR)

(21) Appl. No.: 18/279,759

(22) PCT Filed: Mar. 1, 2022
(86) PCT No.: PCT/EP2022/055120

§ 371 Date: Aug. 31, 2023

(30) Foreign Application Priority Data
Mar. 1, 2021 (WO) PCT/IB2021/051684

(51) Int. Cl. C22C 38/08; B22F 9/08; B22F 10/00; C21D 8/02; C21D 9/52; C22C 38/02; C22C 38/04; C22C 38/16

(52) U.S. Cl. CPC C22C 38/08; B22F 9/08; B22F 10/00; C21D 8/0226; C21D 8/0236; C21D 9/525; C22C 38/02; C22C 38/04; C22C 38/16

(57) ABSTRACT

Disclosed is an iron-nickel alloy having the following composition in percent by weight:
36.5%≤Ni≤38.5%
0.50%≤Mn≤1.25%
0.001%≤Cu≤0.85%
0.040%≤C≤0.150%
0.10%≤Si≤0.35%
   the remainder being iron and unavoidable impurities resulting from the manufacturing.

### CROSS-REFERENCE TO RELATED APPLICATIONS

This application is the US national stage of PCT/EP2022/055120, filed Mar. 1, 2022 and designating the United States, which claims the priority of PCT/IB2021/051684, filed Mar. 1, 2021. The entire contents of each foregoing application are incorporated herein by reference.

### BACKGROUND OF THE INVENTION

### Field of the Invention

The present invention relates to an iron-nickel (Fe—Ni) alloy intended in particular to be used in cryogenic applications, in particular for manufacturing workpieces or assemblies designed to contain liquefied gases, and for example transport tubes or transport/storage tanks for transporting or storing liquefied gases. These workpieces or assemblies are in particular suitable and adapted for receiving liquid hydrogen.

### Description of the Related Art

The materials currently used for the transport of liquefied gases are generally designed for the transport and storage of liquid methane, the boiling point of which is −162° C. However, it is becoming necessary to also produce workpieces or assemblies that are suitably adapted for the transport and storage of liquid hydrogen, the boiling point of which is −253° C.

The inventors of the present invention have noted the fact that the transport and storage of liquid hydrogen using the materials normally used for transporting liquefied gases, for example Invar M93, is likely to pose difficulties, on the one hand on account of the low boiling point of liquid hydrogen and on the other hand on account of the risk of the alloy becoming embrittled by the hydrogen.

More specifically, the inventors of the present invention have found that austenitic structures such as those of Invar M93 can develop a martensitic transformation when the material is subjected to plastic deformation at cryogenic temperatures. The more severe the deformation and the lower the temperature, the higher the martensite content. In the case of Invar M93, the risk of martensitic transformation within the microstructure in the event of a minor mechanical incident during operation of a cryogenic line or tank (impact, crushing, bending, etc) is therefore greatly increased at the temperature of liquid hydrogen (−253° C.). The martensite that is developed within the INVAR M93 microstructure and loaded with hydrogen can then induce hydrogen embrittlement.

### SUMMARY OF THE INVENTION

One objective of the invention is therefore to provide an alloy that exhibits good mechanical properties at the temperature of liquid hydrogen (−253° C.), combined with a low mean coefficient of thermal expansion between 0° C. and −196° C., which can be used in particular for the manufacture of workpieces designed for the transport and storage of liquid hydrogen, for example for the manufacture of tubes or tanks designed for the transport and storage of liquid hydrogen.

To this end, the invention relates to an iron-nickel alloy having the following composition, in percentage by weight:
36.5%≤Ni≤38.5%
0.50%≤Mn≤1.25%
0.001%≤Cu≤0.85%
0.040%≤C≤0.150%
0.10%≤Si≤0.35%
the remainder being iron and unavoidable impurities resulting from the manufacturing.

According to the particular characteristics of the alloy according to the invention:
the carbon content is between 0.040% by weight and 0.075% by weight;
the unavoidable impurities resulting from the manufacturing include, in percentage by weight:
Cr≤0.5%
Co≤0.5%
S≤0.0035%
P≤0.01%
Mo<0.5%
O≤0.0025%
Ca≤0.0015%
Mg≤0.0035%
Al≤0.0085%;
the alloy exhibits a mean coefficient of thermal expansion a between −196° C. and 0° C. that is greater than or equal to 2.0×10⁻⁶° C.⁻¹ and less than or equal to 3.0×10⁻⁶° C.⁻¹, in particular when the alloy is in the form of a hot rolled product.

The invention also relates to a cold strip made of the alloy as described above.

The invention also relates to a strip manufacturing method for manufacturing a cold strip as described above that includes the following successive steps:
an alloy as defined above is produced;
a semi-finished product of the said alloy is formed;
this semi-finished product is hot rolled in order to obtain a hot strip;
the hot strip is cold rolled in one or more passes in order to obtain a cold strip.

The invention also relates to the use of the alloy as defined above for manufacturing tanks or tubes intended for receiving a liquefied gas.

The invention also relates to a filler wire made from the alloy as defined above.

The invention also relates to a wire manufacturing method for manufacturing a filler wire as defined above, the method including the following steps:
provision of a semi-finished product made from an alloy as defined above;
hot transformation of this semi-finished product in order to form an intermediate wire; and
transformation of the intermediate wire into a filler wire, having a smaller diameter than that of the intermediate wire, the said transformation including a step of drawing.

The invention also relates to a workpiece or portion of a workpiece that is made from an alloy as defined above, the said workpiece or workpiece portion being obtained by means of metal additive manufacturing.

The invention also relates to a manufacturing method for manufacturing a workpiece or portion of a workpiece, that includes a step of manufacturing the said workpiece or workpiece portion by a metal additive manufacturing process using, as filler material, a filler wire made from the alloy as defined above, and/or a powder made from the alloy as defined above.

The invention also relates to the use of the filler wire as defined above as filler wire in the context of a metal additive manufacturing process.

The invention also relates to a metal powder made from an alloy as defined above.

The invention also relates to a powder manufacturing method for manufacturing a metal powder as defined above, the said method including a step of providing a filler wire as defined above, as well as a step of plasma atomisation of this filler wire in order to obtain the metal powder.

The invention also relates to a tube section made from an alloy as defined above, the said tube section preferably being seamless.

According to the particular characteristic features, the tube section comprises a sheet bent into the shape of a tube and made from an alloy as defined above, the sheet having longitudinal edges joined to each other by a weld seam.

The invention also relates to a tube manufacturing method for manufacturing a tube section as defined above, that includes the following successive steps:
providing of a sheet made from an alloy as defined above and having two longitudinal edges; and
welding the longitudinal edges of the sheet to each other in order to form the tube section.

The invention also relates to a tube comprising at least two tube sections as defined above, with two successive tube sections being joined to each other by a weld seam.

The invention also relates to a manufacturing method for manufacturing a tube that includes the following successive steps:
providing of a first tube section as defined above and a second tube section as defined above, the first tube section and the second tube section extending along a longitudinal axis;
positioning of the first and second tube sections in a manner such that a longitudinal end of the first tube section is arranged so as to be facing a longitudinal end of the second tube section along the longitudinal axis of the first and second tube sections; and
welding together of two facing longitudinal ends of the first and second tube sections.

The invention also relates to a tank portion comprising at least one portion that is made from an alloy as defined above. The said tank portion is intended for the transport or storage of liquefied gases, and in particular liquid hydrogen.

The invention also relates to a hot strip made of the alloy as described above.

The invention also relates to a strip manufacturing method for manufacturing a hot strip as described above that includes the following successive steps:
an alloy as defined above is produced;
a semi-finished product of the said alloy is formed;
this semi-finished product is hot rolled in order to obtain a hot strip.

### BRIEF DESCRIPTION OF THE DRAWINGS

The invention will be better understood upon reading the description that follows, provided solely by way of example, and made with reference to the appended drawings, in which:

FIG. 1 is a schematic perspective view of a tube section according to a first embodiment of the invention;

FIG. 2 is a schematic perspective view of a tube section according to a second embodiment of the invention;

FIG. 3 is a schematic top view of a sheet used during the implementation of the method for manufacturing a tube section according to the second embodiment;

FIG. 4 is a schematic perspective view of a tube according to the invention; and

FIG. 5 is a schematic perspective view of a workpiece obtained by means of an additive manufacturing process according to the invention.

### DETAILED DESCRIPTION

Throughout the description, the contents are given in percentage by mass.

The alloy according to the invention is an iron-based alloy comprising, in percentage by weight:
36.5%≤Ni≤38.5%
0.50%≤Mn≤1.25%
0.001%≤Cu≤0.85%
0.040%≤C≤0.150%
0.10%≤Si≤0.35%
the remainder being iron and unavoidable impurities resulting from the manufacturing.

The term ‘unavoidable impurities resulting from the manufacturing’, is used to refer to elements that are present in the raw materials used to produce the alloy, or that come from the apparatus used for the production thereof, and for example from the refractories of the furnaces. These impurities have no metallurgical effect on the alloy.

The impurities resulting from the manufacturing include in particular, in percentage by weight:
Cr≤0.5%
Co≤0.5%
S≤0.0035%
P≤0.01%
Mo<0.5%
O≤0.0025%
Ca≤0.0015%
Mg≤0.0035%
Al≤0.0085%.

The alloy according to the invention in particular exhibits a mean coefficient of thermal expansion □ between −196° C. and 0° C. that is greater than or equal to 2.0×10-6° C.-1 and less than or equal to 3.0×10-6° C.-1.

In the alloy according to the invention, the content levels of Ni, Mn, C and Cu, that is to say Ni≥36.5%, Mn≥0.50%, C≥0.040% and Cu≥0.001%, are such as to enhance the stability of the alloy to martensitic transformation at −253° C. (20K), that is to say at the temperature of liquid hydrogen, and thus provide the alloy with the ability to retain an austenitic structure in the event of a minor mechanical incident (impact, crushing, bending, etc.) occurring at the temperature of liquid hydrogen.

The inventors of the present invention have noted that if the content levels of Ni, Mn, C and Cu are below the lower limits described above, the alloy presents an increased risk of hydrogen embrittlement in the event of a minor mechanical incident (impact, crushing, bending, etc.) occurring at the temperature of the liquid hydrogen, characterised by a low elongation at fracture A (A≤10%) and an excessively low striction Z (Z %≤50%).

The elongation at fracture A is determined by means of the standard ASTM A370_July 2019.

The striction Z is determined by means of the French standard NF EN ISO 6892-1_December 2019.

In addition, the upper limits selected for Ni, Mn and Cu, that is to say, Ni≤38.5%, Mn≤1.25% and Cu≤0.85%, make it possible to maintain a mean coefficient of thermal expansion □□ between −196° C. and 0° C. that is less than or equal to 3.0×10-6° C.-1, which provides the ability to limit thermal stresses to a critical value assessed at 110 MPa. This critical stress is equal to approximately 15% of the yield strength of the alloy at the temperature of the liquid hydrogen (Rp(−253° C.)˜ 800 MPa).

The inventors of the present invention have found that if the Ni, Mn and Cu content levels are higher than the upper limits described above, the mean coefficient of thermal expansion □□ between −196° C. and 0° C. has a value greater than 3.0×10-6° C.-1, and is therefore too high for the intended applications.

In addition, when the carbon content is greater than 0.150%, the alloy loses weldability through the formation of porosities during tungsten inert gas (TIG) welding without filler wire. In fact, the presence of carbon at levels greater than 0.150% generates effervescence during TIG welding operations without filler wire. In this case, the weldability of the alloy is degraded.

Preferably, the carbon content is between 0.040% and 0.075% by weight. In this case, the weldability of the alloy is further enhanced.

Preferably, the Mn content is greater than or equal to 0.7% by weight. Such a manganese content level further enhances the stability of the alloy to martensitic transformation at −253° C. (20K).

In the alloy according to the invention, the silicon content is between 0.10% and 0.35% by weight. Silicon at these content levels serves to enable deoxidation of the alloy. At a content level greater than 0.35% by weight, the rate of thermal expansion between −196° C. and 0° C. runs the risk of being too high when the Ni, Mn and Cu content levels are adjusted in accordance with the invention.

The alloy according to the invention may be produced by any suitable method known to the person skilled in the art. By way of example, it is produced in an electric arc furnace or induction furnace, then ladle refined by the usual methods, comprising in particular a vacuum oxygen decarburisation or VOD-type ladle refining step followed by an ASV-type hot ladle metallurgy step. By way of a variant, the alloy according to the invention is produced in a vacuum induction furnace from low-residue raw materials.

The production method for producing the alloy is provided solely by way of example. All other methods for producing the alloy known to the person skilled in the art may be used for this purpose.

The invention also relates to a cold strip having the composition defined above. This cold strip has in particular a thickness of between 0.5 and 10 mm. The thickness of the cold strip is advantageously between 2 mm and 10 mm in the case where the cold strip is intended to be used for the manufacture of a cryogenic tube. The thickness is advantageously between 0.5 mm and 2 mm in the case where the cold strip is intended to be used for the manufacture of a transport/storage tank for transporting or storing liquefied gas.

By way of example, the following method is used for manufacturing such cold strips.

The alloy as described above is cast in the form of semi-finished products such as ingots, remelting electrodes, slabs, in particular thin slabs with a thickness of less than 180 mm, or billets.

When the alloy is cast in the form of a remelting electrode, the latter is advantageously remelted under vacuum or by an electro-conductive slag remelting process in order to obtain greater purity and more homogeneous semi-finished products.

The semi-finished product thus obtained by direct casting is then hot rolled at a temperature of between 950° C. and 1300° C. in order. to obtain a hot strip.

The thickness of the hot strip is in particular between 2 mm and 20 mm, and more particularly between 2 mm and 10 mm.

In the event that the sheet metal being manufactured is intended for a liquefied gas transport or storage tank, the final thickness after hot rolling is for example approximately equal to 3.5 mm.

According to one embodiment, the hot rolling is preceded by a chemical homogenisation heat treatment process carried out on the semi-finished product at a temperature of between 950° C. and 1300° C. for a period of between 30 minutes and 24 hours.

The hot strip is cooled to ambient temperature so as to form a cooled strip, and subsequently wound into coils.

The cooled strip is then cold rolled in order to obtain a cold strip having a final thickness that is advantageously between 0.5 mm and 10 mm. The cold rolling process is carried out in one pass or in multiple successive passes.

In the event that the sheet metal being manufactured is intended for a cryogenic tube, the final thickness after cold rolling is advantageously between 2 mm and 10 mm.

In the event that the sheet metal being manufactured is intended for a liquefied gas transport or storage tank, the final thickness after cold rolling is advantageously between 0.5 and 2 mm.

Optionally, the hot strip is chemically pickled and then shot blasted in order to remove any mill scale prior to cold rolling.

Optionally, the pickled and shot blasted sheets are polished in order to remove the oxidised penetrations at the grain boundaries prior to cold rolling, the desired roughness Ra being in particular less than 50 μm according to standard ISO 4287.

At the final thickness, the cold strip is optionally subjected to a recrystallisation heat treatment process in a static furnace for a period ranging from 10 minutes to several hours and at a temperature in excess of 700° C. By way of a variant, it is subjected to a recrystallisation heat treatment process in a continuous annealing furnace for a period ranging from a few seconds to approximately 1 minute, at a temperature in excess of 800° C. in the holding zone of the furnace, and under a protected atmosphere of the N2/H2 type (30%/70%) with a frost temperature of between −50° C. and −15° C. The frost temperature defines the partial pressure of water vapour contained in the heat treatment atmosphere. Such a treatment process is carried out in particular after the steps of pickling, shot blasting and polishing, as described above, have been carried out.

A recrystallisation heat treatment process is optionally carried out, under the same conditions as the recrystallisation heat treatment process described above, during cold rolling, at an intermediate thickness between the initial thickness (corresponding to the thickness of the hot strip) and the final thickness. For example, the intermediate thickness is chosen to be equal to 1.5 mm when the final thickness of the cold strip is 1.0 mm.

The strip manufacture method for manufacturing cold strips made of this alloy is described by way of example only. Any other method for manufacturing cold strips known to the person skilled in the art may be used for this purpose.

The invention also relates to a section of cryogenic tube made from the alloy as described above. The tube section is intended in particular for transporting liquefied gases, and in particular liquid hydrogen.

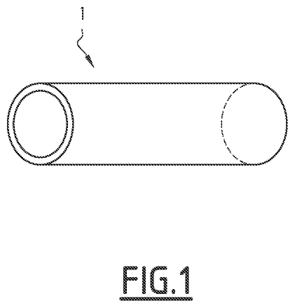

A tube section 1 according to a first embodiment is represented in FIG. 1. This tube section 1 does not comprise a longitudinal weld. It is therefore a tube section with no welding. This tube section 1 is for example obtained by means of extrusion of billets made from the alloy described above.

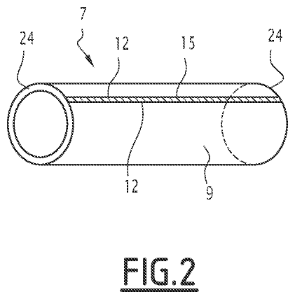

A tube section 7 according to a second embodiment is represented in FIG. 2. The tube section 7 comprises a sheet 9, made of the alloy as described above, and bent into the shape of a tube, of which the longitudinal edges 12 are joined to each other by a weld seam 15. The wall of the tube section 7 has for example a thickness of between 2 mm and 10 mm.

The weld seam is in particular obtained by means of autogenous welding, that is to say, by using a filler wire made from the alloy described above.

By way of a variant, a filler wire with a composition that is different from that described above is used, the composition of the filler wire being selected on the basis of the properties desired, and in particular in order to obtain a weld having a thermal expansion □ between −196° C. and 0° C. that is less than or equal to 5.5. 10-6° C.-1, and mechanical properties that are superior to those of sheet metal.

The invention also relates to a tube manufacturing method for manufacturing such a tube section 7.

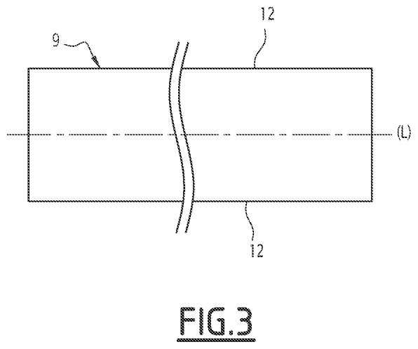

The method includes providing of a sheet 9 made from the alloy as described above. Such a sheet 9 is represented in FIG. 3. It extends along a longitudinal direction L and has longitudinal edges 12 that are substantially parallel to the longitudinal direction L. It has for example a thickness of between 2 mm and 10 mm.

The method further includes a step consisting in bending this sheet 9 in a manner such as to bring together the two longitudinal edges 12 so as to be facing each other, followed by a step consisting in welding the two longitudinal edges 12 to each other by making use of a suitable filler wire, and in particular making use of a filler wire made of the alloy described above.

The weld obtained during this step is a longitudinal weld. Preferably, it is a butt weld.

At the end of this process, a tube section 7 is obtained, as illustrated in FIG. 2, in which the sheet 9 is bent into the shape of a tube, and the longitudinal edges 12 of the sheet 9 are joined to each other by a weld seam 15.

The invention also relates to a cryogenic tube 20 made by assembling the cryogenic tube sections 1, 7 according to the invention. The tube 20 is intended in particular for transporting liquefied gases, and in particular liquid hydrogen.

By way of example, the cryogenic tube 20 comprises at least two tube sections 1, 7 as described above, that are joined to each other by a weld seam 22. The weld seam 22 extends along the circumference of the tube 20 in a manner such as to join the tube sections 1, 7 to each other.

The weld seam 22 is in particular obtained by means of autogenous welding, that is to say by using a filler wire having the composition described above.

The weld is in particular a butt weld, preferably an orbital weld. The term ‘orbital weld’, is used to refer to a weld produced by causing the welding tool, that is to say in particular the welding torches, to revolve around the tube sections 1, 7 to be welded.

The wall of the cryogenic tube 20 has for example a thickness of between 2 mm and 10 mm.

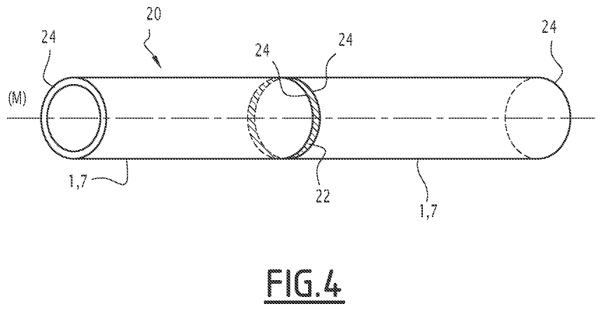

Represented in FIG. 4 is a cryogenic tube 20 obtained by assembling the tube sections 7 according to the second embodiment as described above with reference to FIG. 2.

By way of a variant, the tube 20 is obtained by assembling the tube sections 1 according to the first embodiment as described above with reference to FIG. 1.

The invention also relates to a manufacturing method for manufacturing a cryogenic tube 20 as described above.

During this process, at least two tube sections 1, 7 are provided. Each tube section 1, 7 is substantially cylindrical with an axis M, and has two longitudinal ends 24, spaced apart along the direction of the axis M.

The two tube sections 1, 7 are then positioned in a manner such that their longitudinal ends 24 are arranged so as to be facing each other in the direction of the axis M of these tube sections 1, 7; and thereafter the facing longitudinal ends 24 of the two tube sections 1, 7 are welded to each other using a filler wire, and in particular a wire made of the alloy described above.

Advantageously, during this step, a butt weld between the facing longitudinal ends 24 of the tube sections 1, 7 is produced. The weld is preferably an orbital weld.

Preferably, the welding step comprises, prior to the joining together of the tube sections 1, 7, a machining step for machining chamfers at the ends 24 of the tube sections 1, 7 to be welded to each other.

The welding step is carried out repeatedly, with the number of times being equal to the number of tube sections 1, 7 to be welded together to form the tube 20 reduced by one.

According to one embodiment, the tube sections are tube sections 1 according to the first embodiment as described above. By way of a variant, the tube sections are tube sections 7 according to the second embodiment as described above.

At the end of the said one or more welding steps, the cryogenic tube 20 is obtained. This cryogenic tube 20 comprises at least two successive tube sections 1, 7 assembled to each other by a weld seam 22.

The invention also relates to a portion of a tank for transporting or storing liquefied gases, which is made from the alloy described above.

The invention also relates to a filler wire made from the alloy as described above.

Such a filler wire is in particular intended to be used in the context of an additive manufacturing process or as a filler wire for welding to each other two workpieces or portions of a workpiece, the workpieces or workpiece portions being for example made of the alloy described above.

Such a filler wire is in particular produced by implementing the following method.

This method includes, in a first step, the providing of a semi-finished product made from the alloy as described above.

To this end, the alloy, produced according to the methods described above, is either cast in ingots, or cast directly in the form of billets, in particular by means of continuous casting, in particular rotary casting. The semi-finished products obtained at the end of this step are therefore advantageously ingots or billets, and have for example a diameter of between 130 and 230 mm, and more particularly equal to approximately 150 mm.

Thereafter, the semi-finished products are transformed by means of hot transformation in order to form an intermediate wire.

In particular, during this hot transformation step, the semi-finished products, that is to say in particular the ingots or billets, are heated, in particular in a gas furnace, to a temperature of between 1150° C. and 1250° C.

They are then subjected to a hot roughing process, followed by a hot rolling process, in particular on a wire mill, at a temperature of between 950° C. and 1150° C., and then by a hyper-quenching process at the exit of the rolling mill. The intermediate wire may in particular be a wire rod. For example, it has a diameter of between 5 mm and 21 mm, and in particular approximately equal to 5.5 mm.

The hyper-quench is in particular a hyper-quenching in a bath at 20° C., after a heat treatment process in a gas furnace, at a temperature of between 1050° C. and 1150° C. for a period of between 20 minutes and 120 minutes.

The intermediate wire is subsequently stripped and wound in the form of a spool.

Optionally, the intermediate wire or wire rod thus obtained is drawn by means of a drawing installation of known type in order to obtain the filler wire. This filler wire has a smaller diameter than the initial wire. In particular, its diameter is between 0.5 mm and 3.5 mm. Advantageously, it is between 0.8 mm and 2.4 mm.

Depending on the final diameter to be achieved, the drawing step comprises one or more drawing passes, preferably with an annealing process between two successive drawing passes. This annealing is for example carried out during drawing under a reducing atmosphere at a temperature of around 1150° C.

The drawing step is preferably followed by a process of cleaning of the surface of the drawn wire, and then by the winding of the wire.

The drawing passes are cold drawing passes.

In particular, for the manufacture of a filler wire with a diameter approximately equal to 1.6 mm, two drawing passes are used, with the second drawing pass resulting in the final diameter of approximately 1.6 mm.

For the manufacture of a filler wire with a diameter approximately equal to 1.2 mm, three drawing passes are for example used, with the second drawing pass resulting in a diameter of approximately 1.6 mm and the third drawing pass resulting in the final diameter of 1.2 mm.

The wire manufacturing method for manufacturing filler wire is described by way of example only. All other suitable methods for manufacturing filler wires known to the person skilled in the art may be used for this purpose.

The invention also relates to a metal powder for additive manufacturing that is produced from the alloy as described above, the particle size of which after being screened is advantageously between 10 μm and 200 μm.

Such a powder is, for example, manufactured by means of plasma atomisation from a wire made from an alloy as described above, the wire in particular having a diameter of approximately 3 mm.

The particle size of the powder is determined in particular in accordance with the following measuring method. Batches of powder are separated into a number of powder size distributions by means of ultrasonically vibrating stainless steel sieves. The analysis of the powder size distribution obtained following the screening process is carried out in accordance with the standard ASTM B214-07. The screening enables 5 classes of sizes to be obtained: <20 μm-20 μm to 45 μm-45 μm to 75 μm-75 μm to 105 μm->105 μm.

The plasma atomisation process is known per se, and is therefore not described in detail.

The filler wire is also intended, for example, to be used as a filler wire in the context of a metal additive manufacturing process.

The additive manufacturing process is, for example, an additive manufacturing process that uses an electric arc, a laser beam and/or an electron beam as an energy source in order to bring about the melting of the filler wire.

In particular, the additive manufacturing process is a Directed Energy Deposition additive manufacturing process. During this process, the filler material is deposited, in particular by means of a nozzle, and immediately melted by concentrated thermal energy, in particular by a laser beam, an electron beam and/or an electric arc.

By way of example, the additive manufacturing process is a process based on wire-arc (“Wire Arc Additive Manufacturing” or “WAAM” as per accepted terminology), wire-Laser, wire-electron beam (“Electron Beam Free Form Fabrication” or “Electron Beam Additive Manufacturing” in English as per accepted terminology), or a hybrid additive manufacturing process combining wire-arc and powder-Laser, or wire-arc and wire-Laser technologies.

The wire used in the context of these processes is the filler wire as described above.

In the case of a hybrid wire-arc and powder-Laser process, the powder used has the same composition as the wire.

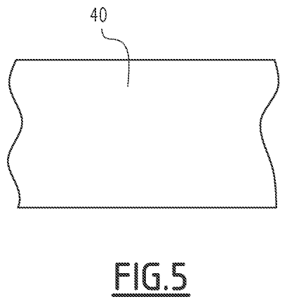

The invention also relates to a workpiece manufacturing method for manufacturing a workpiece 40 as represented schematically in FIG. 5 or a portion of a workpiece, made from an alloy as described above, which includes:
the providing of a filler wire made from this alloy; and
the manufacture of the workpiece 40 or the workpiece portion by means of a metal additive manufacturing process using, as filler material, a filler wire made from the alloy as described above and/or a powder made from the alloy as described above.

The additive manufacturing process is for example an additive manufacturing process using an electric arc, a laser beam, and/or an electron beam as an energy source in order to bring about the melting of the filler material.

In particular, the additive manufacturing process is a “Directed Energy Deposition” additive manufacturing process. During this process, the filler material is deposited, in particular by a nozzle, and immediately melted by concentrated thermal energy, in particular by means of a laser beam, an electron beam and/or an electric arc.

By way of example, the additive manufacturing process is a process based on wire-arc (“Wire Arc Additive Manufacturing” or “WAAM” as per accepted terminology), wire-Laser, wire-electron beam (“Electron Beam Free Form Fabrication” or “Electron Beam Additive Manufacturing” in English as per accepted terminology), or a hybrid additive manufacturing process combining wire-arc and powder-Laser, or wire-arc and wire-Laser technologies.

In the case where a hybrid additive manufacturing process combining wire-arc and powder Laser, or wire arc and wire Laser technologies is used, the powder and the filler wire are made from the alloy as described above.

The additive manufacturing processes mentioned above are known per se, and are therefore not described in detail herein.

The invention also relates to a workpiece 40 or portion of a workpiece that is made from an alloy as described above, obtained by means of a metal additive manufacturing process.

This metal additive manufacturing process uses in particular, as filler material, a filler wire made from the alloy as described above and/or a powder made from the alloy as described above.

A workpiece or portion of a workpiece obtained by means of a metal additive manufacturing process, such as the workpiece 40, is an as-solidified workpiece. It therefore has a solidification microstructure that is typical of the alloy in consideration, such a microstructure typically comprising columnar dendrites that grow one on top of the other by epitaxy and the orientation of which depends on the width and height of the metal wall produced. Furthermore, a workpiece obtained by an additive manufacturing process has, as a result of its additive manufacturing process, a succession of superimposed solidification strata. Each stratum, obtained by solidification of the deposited drops of molten metal, remelts the skin of the preceding stratum in order to generate metallurgical continuity, and as a result reheats the rest of the lower strata. The farther away the stratum in question is from the zone in the process of melting and solidification, the lower the reheating temperature will be. This particular microstructure may be observed by means of metallographic observation on the metallographic cross sections of the workpieces.

A workpiece 40 or a workpiece portion obtained by means of a metal additive manufacturing process can thus be distinguished from workpieces obtained by other processes, and in particular from a workpiece obtained by conventional metallurgy which produces a recrystallised structure with homogeneous grains.

The workpiece 40 or workpiece portion is in particular a special workpiece or workpiece portion, such as a valve, a tube connector or some other workpiece, in particular used in the context of cryogenic applications, and more particularly at the temperature of liquid hydrogen, for example in the context of the transport and storage of liquid hydrogen.

According to one example, the workpiece 40 is a tubular connector intended to serve as a connector between a plurality of coaxial tubes, in particular between a double-walled tube and a single-walled tube, for example in a pipeline. Such a connector is referred to as a “bulkhead” as per accepted terminology. The bulkhead is a component that is well-known in the field of pipelines.

Tests

The alloys used in tests nos 1 to 22 were produced under vacuum and cast in mini ingots weighing approximately 2 kg. These ingots were machined into bars measuring 35 mm on each side and 100 mm in height. These bars were then reheated to 1220° C. for a period of 8 hours under argon gas, after which they were hot rolled at approximately 1150° C. in order to obtain sheet bars measuring 750×35×4 mm.

The chemical compositions, in % by weight, of the alloy elements in the sheet bars obtained are defined in Table 1 here below. The approximate mass contents of impurities in the sheet bars resulting from the manufacturing process are indicated in Table 2 here below.

TABLE 1
Compositions of sheet bars (in % by weight)

| No | Ni | Mn | Cu | C | Si | Fe |
|---|---|---|---|---|---|---|
| 1 | 35.9 | 0.14 | 0.01 | 0.001 | 0.10 | Remainder |
| 2 | 36.0 | 0.35 | 0.01 | 0.029 | 0.10 | Remainder |
| 3 | 36.0 | 0.46 | 0.01 | 0.035 | 0.10 | Remainder |
| 4 | 36.5 | 0.53 | 0.01 | 0.041 | 0.10 | Remainder |
| 5 | 37.4 | 0.56 | 0.01 | 0.046 | 0.10 | Remainder |
| 6 | 38.4 | 0.54 | 0.01 | 0.051 | 0.10 | Remainder |
| 7 | 39.5 | 0.56 | 0.01 | 0.047 | 0.10 | Remainder |
| 8 | 36.0 | 0.11 | 0.01 | 0.035 | 0.10 | Remainder |
| 9 | 36.6 | 0.77 | 0.01 | 0.057 | 0.10 | Remainder |
| 10 | 37.0 | 1.00 | 0.01 | 0.053 | 0.10 | Remainder |
| 11 | 36.9 | 1.23 | 0.01 | 0.043 | 0.10 | Remainder |
| 12 | 37.0 | 1.24 | 0.01 | 0.045 | 0.10 | Remainder |
| 13 | 37.0 | 1.48 | 0.01 | 0.046 | 0.10 | Remainder |
| 14 | 36.6 | 0.58 | 0.25 | 0.072 | 0.10 | Remainder |
| 15 | 36.7 | 0.59 | 0.49 | 0.080 | 0.10 | Remainder |
| 16 | 36.6 | 0.61 | 0.83 | 0.069 | 0.10 | Remainder |
| 17 | 37.0 | 0.50 | 0.99 | 0.071 | 0.10 | Remainder |
| 18 | 37.0 | 0.50 | 0.36 | 0.071 | 0.10 | Remainder |
| 19 | 37.0 | 0.53 | 0.34 | 0.092 | 0.10 | Remainder |
| 20 | 37.1 | 0.53 | 0.36 | 0.094 | 0.10 | Remainder |
| 21 | 37.0 | 0.53 | 0.37 | 0.146 | 0.10 | Remainder |
| 22 | 37.0 | 0.50 | 0.34 | 0.195 | 0.10 | Remainder |

In Table 1 above, the examples that are not in accordance with the invention are underlined.

TABLE 2
Approximate mass content levels in the sheet bars of impurities
resulting from the manufacturing process (in % by weight)

| S | P | Al | Mg | Ca | Cr | Co | O | Mo |
|---|---|---|---|---|---|---|---|---|
| 0.0003 | 0.0080 | 0.0050 | 0.0015 | 0.0004 | <0.5 | <0.5 | <0.0025 | <0.5 |

Prismatic flat tensile test specimens (2 per composition, in accordance with the standard ASTM A370-July 2019) and cylindrical dilatometry test specimens measuring 3 mm in diameter and 50 mm in length (1 per composition) were then machined from the sheet bars thus produced in order to form the test specimens for the hydrogen embrittlement sensitivity study and the thermal expansion measurements.

At an initial stage, the tensile specimens were subjected to heat treatment under 99.999% pure hydrogen over a period of 4 hours at 1100° C., followed by rapid cooling in the cold zone of the furnace. The period of cooling was approximately 45 seconds. The objective of this heat treatment is to load the specimens with atomic hydrogen (H).

At a subsequent stage, the tensile specimens (loaded with hydrogen) were pre-strained at two different temperatures with a strain rate of 5×10-3 s-1:
Specimens A, 10% pre-strained at the temperature of liquid Helium (−268° C.). The objective of pre-straining at −268° C. is to develop more or less martensite, depending on the stability of the alloy, and under thermal conditions that are more severe than those of liquid hydrogen (−253° C.).
Specimens B, 10% pre-strained at ambient temperature (20° C.). The objective of the 10% pre-straining at ambient temperature is to provide reference specimens, free of martensite, but with the same strain rate as those strained at −268° C., and which are likely to contain martensite. These specimens will provide the non-brittle reference state.

Finally, the Specimens A and B were flat tensile strain-tested until fracture, with a slow strain rate of 5×10-5 s-1, at −50° C. (+/−5° C.). The testing carried out in this manner is referred to as the “slow tensile and fracture at −50° C.” test. The time period between the hydrogen loading and the slow tensile test at −50° C. never exceeded 48 hours.

The hydrogen sensitivity of the specimens thus subjected to the slow tensile and fracture testing at −50° C. was assessed by measuring the total elongation at fracture A %, and the striction Z %=(S0−S)/S0, as measured using a 25× optical microscope. S0 and S are respectively the initial cross-sections prior to pre-straining, and the final cross-sections with the narrowest diameter. The results of these measurements are indicated in the columns “A %” and “Z %” for the Specimens A and B in Table 3 here below.

In addition, the expansion of the alloys AL was measured upon cooling between 0° C. and −196° C. (temperature of liquid nitrogen), and then the mean coefficient of thermal expansion □ [−196° C._0° C.] between −196° C. and 0° C. was calculated according to the expression: α[−196° C._0° C.]=1/L0×ΔL/ΔT, where ΔT=0−(−196) and L0 is the initial length of the specimen (50 mm). The results of these measurements and calculations are indicated in the column “α” of Table 3 here below.

The results are presented in Table 3 here below.

TABLE 3
Results of the Tests

| | α | | | | |
|---|---|---|---|---|---|
| | [−196° C._0° C.] | Specimen A | | Specimen B | |
| No | (×10⁻⁶ ° C.⁻¹) | A % | Z % | A % | Z % |
| 1 | 1.3 | 6 | 10 | 19 | 90 |
| 2 | 1.6 | 8 | 15 | 18 | 88 |
| 3 | 1.8 | 10 | 45 | 17 | 80 |
| 4 | 2.0 | 15 | 85 | | |
| 5 | 2.5 | 17 | 75 | | |
| 6 | 3.0 | 18 | 88 | | |
| 7 | 3.6 | 18 | 88 | | |
| 8 | 1.3 | 10 | 25 | 16 | 85 |
| 9 | 2.3 | 13 | 70 | | |
| 10 | 2.7 | 14 | 75 | | |
| 11 | 2.9 | 15 | 85 | | |
| 12 | 3.0 | 17 | 86 | | |
| 13 | 3.2 | 17 | 85 | | |
| 14 | 2.4 | 17 | 85 | 17 | 85 |
| 15 | 2.6 | 16 | 83 | | |
| 16 | 2.9 | 18 | 83 | | |
| 17 | 3.2 | 18 | 83 | | |
| 18 | 2.6 | 17 | 85 | 18 | 88 |
| 19 | 2.6 | 17 | 86 | | |
| 20 | 2.7 | 18 | 86 | | |
| 21 | 2.6 | 18 | 80 | | |
| 22 | 2.6 | 17 | 88 | | |

In Table 3 above, the examples that are not in accordance with the invention are underlined.

For the compositions no 3 to no 7, the reference for the tensile tests is the Specimen B corresponding to the composition no 3. Indeed, within this group of compositions, it was considered that the ductility after “slow tension and fracture at −50° C.” was independent of the composition.

In a similar manner, for the compositions no 8 to no 13, the reference for the tensile tests is the Specimen B corresponding to the composition no 8; for the compositions no 14 to no 17, the reference for the tensile tests is the Specimen B corresponding to the composition no 14; and for the compositions no 18 to no 22, the reference for the tensile tests is the Specimen B corresponding to the composition no 18.

In the case of tests nos. 1, 2, 3 and 8, in which the content levels of Ni, Mn, C and/or Cu are lower than the lower limits described above for these elements, it can be observed that the test Specimens A exhibit hydrogen embrittlement characterised by a low elongation at fracture A (A≤10%) and an excessively low striction (Z≤50%).

The reference Specimens B, 15% pre-strained at ambient temperature, display normal ductility with A %˜18% and Z %˜88%.

In the case of tests nos 7, 13 and 17, in which the content levels of Ni, Mn and/or Cu are higher than the upper limits described above for these elements, it can be observed that the mean coefficients of thermal expansion a between −196° C. and 0° C. present a degraded value that is greater than 3.0×10-6° C.-1.

Test no 22 is non-compliant insofar as the carbon content is too high (C>0.150%). In this case, the inventors have noted that the alloy loses weldability through the formation of porosities during TIG welding without filler wire. In fact, the presence of carbon then generates effervescence during the TIG welding operations without filler wire.

In the case of tests nos 4 to 6, 9 to 12, 14 to 16, and 18 to 21, which are in accordance with the invention, a satisfactory trade-off is obtained in terms of properties between low thermal expansion (mean coefficient of thermal expansion a between −196° C. and 0° C. that is greater than or equal to 2.0×10-6° C.-1 and less than or equal to 3.0×10-6° C.-1) and resistance to hydrogen embrittlement (elongation at fracture A greater than 10% and striction Z greater than 50%).

These alloys therefore exhibit good mechanical properties at the temperature of liquid hydrogen (−253° C.), combined with a low mean coefficient of thermal expansion a between −196° C. and 0° C.

The alloys according to the invention are therefore particularly suitable for use in applications using liquid hydrogen (−253° C.), and in particular for manufacturing assemblies designed to contain hydrogen, and in particular transport tubes or transport/storage tanks for transporting or storing liquid hydrogen. Needless to say, these alloys may also be used for cryogenic applications that are less restrictive than those concerning liquid hydrogen, for example for the transport or storage of liquefied gases having a boiling point higher than that of liquid hydrogen.

1. An iron-nickel alloy having the following composition, in percentage by weight:
36.5%≤Ni≤38.5%
0.50%≤Mn≤1.25%
0.001%≤Cu≤0.85%
0.040%≤C≤0.150%
0.10%≤Si≤0.35%
the remainder being iron and unavoidable impurities resulting from the manufacturing.

2. The alloy according to claim 1, in which the carbon content is between 0.040% by weight and 0.075% by weight.

3. The alloy according to claim 1, in which the unavoidable impurities resulting from the manufacturing include, in percentage by weight:
Cr≤0.5%
Co≤0.5%
S≤0.0035%
P≤0.01%
Mo<0.5%
O≤0.0025%
Ca≤0.0015%
Mg≤0.0035%
Al≤0.0085%.

4. A cold strip comprising the alloy according to claim 1.

5. A manufacturing method for manufacturing a cold strip comprising the alloy of claim 1, comprising the following successive steps:
manufacturing an alloy according to claim 1;
forming a semi-finished product of the said alloy;
hot rolling this semi-finished product in order to obtain a hot strip;
cold-rolling the hot strip in one or more passes in order to obtain a cold strip.

6. A tank or tube comprising the alloy of claim 1, the tank or tube being configured to be suitable for receiving a liquefied gas.

7. A filler wire comprising the alloy according to claim 1.

8. A manufacturing method for manufacturing a filler wire comprising the alloy of claim 1, the method comprising:
providing a semi-finished product made from an alloy according to claim 1;
hot transforming this semi-finished product in order to form an intermediate wire; and
transforming the intermediate wire into a filler wire, having a smaller diameter than that of the intermediate wire, the said transformation including a step of drawing.

9. A workpiece or portion of a workpiece that is made from an alloy according to claim 1, the said workpiece or portion of a workpiece being obtained by metal additive manufacturing.

10. A workpiece manufacturing method for manufacturing a workpiece or portion of a workpiece, comprising a step of manufacturing the said workpiece or portion of a workpiece by a metal additive manufacturing process using, as filler material, a filler wire made from the alloy according to claim 1, and/or a powder made from the alloy according to claim 1.

11. (canceled)

12. A metal powder comprising the alloy according to claim 1.

13. A manufacturing method for manufacturing a metal powder comprising the alloy of claim 1, the method comprising:
providing a filler wire comprising the alloy of claim 1, and
plasma atomizing the filler wire in order to obtain the metal powder.

14. A tube section comprising the alloy according to claim 1.

15. (canceled)

16. A manufacturing method for manufacturing a tube section, the method comprising:
providing of a sheet comprising the alloy according to claim 1 and having two longitudinal edges;
bending the two longitudinal edges toward one another to form a tube shape; and
welding the longitudinal edges of the sheet to each other in order to form the tube section.

17. A tube comprising at least two of the tube sections according to claim 14, with two successive tube sections being interconnected by a weld seam.

18. A manufacturing method for manufacturing a tube, the method comprising:
providing of a first said tube section of claim 14 and a second said tube section of claim 14, the first tube section and the second tube section being arranged to extend along a longitudinal axis,
positioning of the first and second tube sections in a manner such that a longitudinal end of the first tube section is arranged so as to be facing a longitudinal end of the second tube section along the longitudinal axis of the first and second tube sections; and
welding together the two facing longitudinal ends of the first and second tube sections.

19. A tank portion comprising at least one portion that is made from an alloy according to claim 1.

20. A hot strip comprising the alloy according to claim 1.

21. A manufacturing method for manufacturing a hot strip comprising the alloy of claim 1, the method comprising:
producing the alloy according to claim 1;
forming a semi-finished product of the alloy;
hot rolling the semi-finished product in order to obtain a hot strip.
